(19) United States
(12) Patent Application Publication
(10) Pub. No.: US 2026/0084230 A1
(43) Pub. Date: Mar. 26, 2026

(54) WELDED JOINT

(71) Applicant: NIPPON STEEL CORPORATION, Tokyo (JP)

(72) Inventors: Takuya MITSUNOBU, Tokyo (JP); Takafumi YOKOYAMA, Tokyo (JP); Hiroshi TAKEBAYASHI, Tokyo (JP)

(73) Assignee: NIPPON STEEL CORPORATION, Tokyo (JP)

(21) Appl. No.: 19/109,090

(22) PCT Filed: Sep. 6, 2023
(86) PCT No.: PCT/JP2023/032486

§ 371 Date: Mar. 5, 2025

(30) Foreign Application Priority Data
Sep. 6, 2022 (JP) 2022-141560

(51) Int. Cl. B23K 9/23; C22C 18/04; C22C 38/00; C22C 38/02; C22C 38/04; C22C 38/06; C23C 2/06

(52) U.S. Cl. CPC B23K 9/23; C22C 38/002; C22C 38/02; C22C 38/04; C22C 38/06; C23C 2/06; C22C 18/04

(57) ABSTRACT

The present invention has as its technical problem to provide a welded joint suppressed in LME cracking at the time of production. The welded joint of the present invention has a plated steel sheet forming the welded joint having a predetermined chemical composition, has a depth with a C concentration measured by GDS of 0.05% or less in a depth direction of the base material starting from an interface of the plating layer and the base steel sheet at a non-heat affected zone of the plated steel sheet of 5 μm or more, has a roughness of the interface of the plating layer and the base steel sheet at a cross-section of the steel sheet of the non-heat affected zone of an Ra of 3.0 μm or less, and has a C concentration at a depth of 5 μm of the base steel sheet starting from an interface of the plating layer and the base steel sheet of the plated steel sheet in a range of 0 to 100 μm from a bead toe of the welded part to an opposite direction from the welded part of 0.05% or less.

### FIELD

The present invention relates to a welded joint. More specifically, the present invention relates to a welded joint suppressing LME cracking at the time of production.

### BACKGROUND

In recent years, the steel sheet used in automobiles, household electric appliances, building materials, and other various fields has been made increasingly higher in strength. For example, in the automotive field, high strength steel sheet is often used for welded structures obtained by arc welding for the purpose of lightening the weight of car bodies so as to improve fuel efficiency.

In welding of steel sheet which has been galvanized, in particular high strength steel sheet, for example, as described in PTL 1, sometimes the drop in weldability due to liquid metal embrittlement (LME) cracking becomes a problem. LME cracking is believed to occur because at the time of welding, the surface layer part of steel sheet transforms to austenite, the molten zinc invading the grain boundaries causes the steel sheet to become brittle and further tensile stress acts on the steel sheet at the time of welding.

Note that, PTL 2 discloses, as steel sheet suppressed in LME cracking and improved in weldability, steel sheet at the surface layer part of which Si oxide particles with a particle size of 20 nm or more are present in a number density of 3000 to 6000/mm² and in a suitable particle size distribution.

### CITATIONS LIST

### Patent Literature

[PTL 1] WO2019/116531
[PTL 2] WO2020/218575

### SUMMARY

### Technical Problem

To prevent LME cracking at the time of production of a welded joint, it is effective to keep the Zn etc. contained in the plating layer from penetrating steel sheet transformed to austenite. There is room for improvement on this point.

The present invention has as its technical problem, in consideration of such a situation, to provide a lap fillet arc welded joint suppressing LME cracking at the time of production.

### Solution to Problem

The inventors engaged in in-depth studies for solving the above technical problem. As a result, they discovered that by including Si and Al in large amounts in steel sheet for arc welding, rendering the steel sheet a suitable surface condition, and performing high dew point annealing, the surroundings of the welded part are decarburized, the ferrite (a) phase is stabilized, and the low C concentration of the steel sheet surface layer around the welded part can be maintained at the time of production of the welded joint whereby it becomes possible to suppress LME.

The present invention was made by engaging in further studies based on the above findings and has as its gist the following:

(1) A welded joint comprises two plated steel sheets with tensile strengths of 780 MPa or more joined by arc welding, wherein the welded joint comprises a welded part, heat affected zone, and non-heat affected zone; the plated steel sheets comprises a base steel sheet and plating layer, the plating layer being formed at least at part of the non-heat affected zone, the plating layer containing Zn; the chemical composition of the base steel sheet of the two steel sheets comprises C: 0.05 to 0.40%, Si: 0.7 to 3.0%, Mn: 0.1 to 5.0%, sol. Al: 0.2 to 2.0%, P: 0.0300% or less, S: 0.0300% or less, N: 0.0100% or less, B: 0 to 0.010%, Ti: 0 to 0.150%, Nb: 0 to 0.150%, V: 0 to 0.150%, Cr: 0 to 2.00%, Ni: 0 to 2.00%, Cu: 0 to 2.00%, Mo: 0 to 1.00%, W: 0 to 1.00%, Ca: 0 to 0.100%, Mg: 0 to 0.100%, Zr: 0 to 0.100%, Hf: 0 to 0.100%, and REM: 0 to 0.100% and a balance of Fe and impurities; a total value of contents of Si and sol. Al is 1.0% or more; at the non-heat affected zone, a depth with a C concentration measured by GDS of 0.05% or less in a depth direction of the base steel sheet starting from an interface of the plating layer and the base steel sheet of the plated steel sheet is 5 μm or more, a roughness of the interface of the plating layer and the base steel sheet at a cross-section of the plated steel sheet is an Ra of 3.0 μm or less; and in a range of 0 to 100 μm from a bead toe of the welded part to an opposite direction from the welded part, a C concentration at a depth of 5 μm of the base steel sheet starting from an interface of the plating layer and the base steel sheet of the plated steel sheet is 0.05% or less.

(2) The welded joint of the above (1) wherein the depth with a C concentration measured by GDS of 0.05% or less in a depth direction of the base steel sheet starting from an interface of the plating layer and the base steel sheet at the non-heat affected zone of the plated steel sheet is 15 μm or more.

(3) The welded joint of the above (1) wherein the roughness of the interface of the plating layer and the base steel sheet at a cross-section of the plated steel sheet of the non-heat affected zone is an Ra of 2.0 μm or less.

(4) The welded joint of the above (1) wherein the depth with a C concentration measured by GDS of 0.05% or less in a depth direction of the base steel sheet starting from an interface of the plating layer and the base steel sheet at the non-heat affected zone of the plated steel sheet is 15 μm or more and the roughness of the interface of the plating layer and the base steel sheet at a cross-section of the plated steel sheet of the non-heat affected zone is an Ra of 2.0 μm or less.

(5) The welded joint of any of the above (1) to (4) wherein in a range of 0 to 100 μm from a bead toe of the welded part to an opposite direction from the welded part, the C concentration at a depth of 5 μm of the base steel sheet starting from an interface of the plating layer and the base steel sheet of the plated steel sheet is 0.02% or less.

(6) The welded joint of any of the above (1) to (4) wherein in a range of 0 to 100 μm from a bead toe of the welded part to an opposite direction from the welded part, the C concentration at a depth of 5 μm of the base steel sheet starting from an interface of the plating layer and the base steel sheet of the plated steel sheet is 0.01% or less.

### Advantageous Effects of Invention

According to the present invention, it is possible to obtain a welded joint suppressing LME cracking at the time of production.

### BRIEF DESCRIPTION OF DRAWINGS

FIG. 1 is a view showing an outline of the vicinity of a welded part of one example of a welded joint of the present invention.

FIG. 2 is a view showing an outline of the vicinity of a welded part of another example of a welded joint of the present invention.

### DESCRIPTION OF EMBODIMENT

Below, the present invention will be explained. The present invention is not limited to the following embodiment. First, an outline of improvement of the LME resistance at the time of production in the welded joint of the present invention will be explained.

LME cracking is believed to occur due to a surface layer part of steel sheet being heated at the time of welding, the structure transforming to austenite, and molten zinc formed by melting of the plating penetrating the grain boundaries of the austenite causing the steel sheet to become brittle and, further, due to application of tensile stress to the steel sheet at the time of welding. The welded joint of the present invention improves the LME resistance by the structure formed at the surface layer of the steel sheet forming the welded joint. Note that, in the Description, the “surface layer of the steel sheet” means the range from the surface of the steel sheet down to a depth of 100 μm.

Specifically, in the welded joint of the present invention, at the non-heat affected zone, the depth with a C concentration measured by GDS of 0.05% or less in the depth direction of the base material starting from the interface of the plating layer and base steel sheet of the plated steel sheet forming the welded joint (below, sometimes simply referred to as the “steel sheet”) is 5 μm or more. This means that at the surface layer of the plated steel sheet forming the welded joint, the concentration of C, which is an element easily causing LME, is low. Usually, if heating steel sheet such as with annealing, external oxidation occurs in which oxides (scale) are formed at the steel sheet surface, decarburization becomes harder to proceed, and the C concentration at the surface layer becomes harder to lower. In the present invention, at the time of production of steel sheet forming the welded joint, strong strain is imparted to the surface layer without increasing the surface roughness of the steel sheet so as to thereby promote diffusion of oxygen to the inside of the material and enable reduction of the C concentration at the surface layer of the steel sheet.

Further, in the welded joint of the present invention, in a range of 0 to 100 μm from a bead toe of the welded part to an opposite direction from the welded part, a C concentration at a depth of 5 μm of the base steel sheet starting from an interface of the plating layer and the base steel sheet of the plated steel sheet is 0.05% or less. That is, in the heat affected zone as well, the C concentration becomes low. Here, the “heat affected zone” means the nonmelted part of the steel sheet changed in structure, metallurgical properties, mechanical properties, etc. by weld heat. The heat affected zone can be confirmed by observation of the cross-section in the sheet thickness direction under an SEM. Note that, the “non-heat affected zone” is a part other than the heat affected zone. The range of 0 to 100 μm from a bead toe of the welded part to an opposite direction from the welded part may be judged to be the heat affected zone.

In this way, the issue becomes how to form a structure where the C concentration does not become higher even if being affected by weld heat. In the steel sheet forming the welded joint of the present invention, Si, which in the past had been known for lowering the LME resistance if contained in the steel, is made to be included in a large amount. This is due to the fact that, as a result of studies by the inventors, it was discovered that opposite to the findings in the past, that including Si in a large amount along with sol. Al causes the LME resistance at the time of production of a welded joint to be improved. This is believed to be because by annealing at a high dew point at the time of production of steel sheet, internal oxides are formed and formation of external oxides is suppressed, so due to the effect of the Si contained in the large amount, the ferrite is stabilized and the low C concentration of the surface layer of the steel sheet in the vicinity of the welded part is maintained at the time of production of the welded joint.

That is, the welded joint of the present invention enables improvement of the LME resistance at the time of production of the welded joint by forming on the surface layer of the steel sheet a structure with a low C concentration even if being affected by the heat due to welding by the combined effect of the high content of Si of the steel sheet forming the welded joint, imparting strain to the surface layer before annealing, and control of the dew point at the time of annealing.

Below, the present invention will be explained in detail.

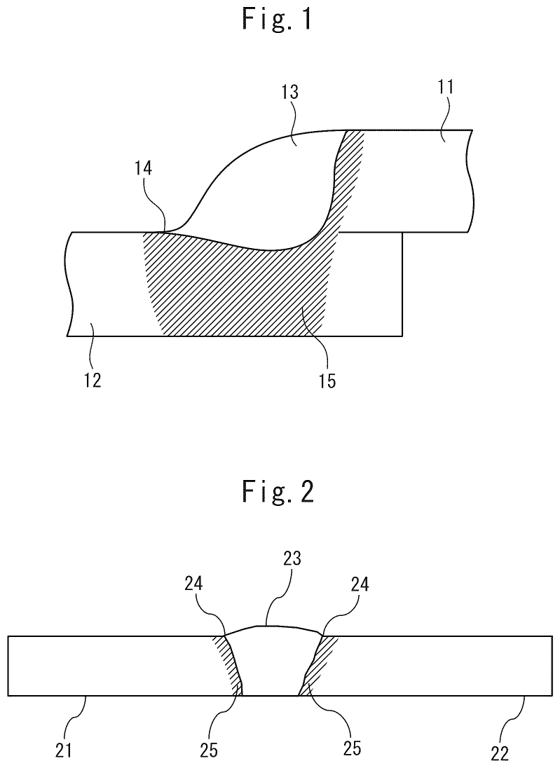

The welded joint of the present invention is comprised of two steel sheets arc welded together. Referring to the drawings, the configuration of the welded joint of the present invention will be explained. FIG. 1 is a view showing an outline of the vicinity of a welded part of a welded joint comprised of two overlaid steel sheets joined by arc welding (lap fillet welding). The two steel sheets 11 (top sheet) and 12 (bottom sheet) are joined by a welded part 13 comprised of a weld bead formed by arc welding. FIG. 1 is a vertical cross-sectional view. The steel sheets 11 and 12 and the welded part 13 extend in the direction vertical to the paper surface. The welded part 13 has a bead toe 14 where the surface of the weld bead and the surface of the steel sheet cross. In the vicinity of the welded part 13, a heat affected zone 15 in structure, metallurgical properties, mechanical properties, etc. by weld heat is formed.

The welded joint of the present invention may also be a welded joint comprised of two abutting steel sheets joined by arc welding (butt welding). FIG. 2 is a view showing an outline of the vicinity of a welded joint joined by butt welding. Two steel sheets 21, 22 are joined by a welded part 23 comprised of a weld bead formed by arch welding. FIG. 2 is a vertical cross-sectional view. The steel sheets 21, 22 and the welded part 23 extend in the direction vertical to the paper surface. The welded part 23 has a bead toe 24 where the surface of the weld bead and the surface of the steel sheet cross. In the vicinity of the welded part 23, a heat affected zone 25 is formed.

In both the case of the welded joint formed by lap fillet welding shown in FIG. 1 and in the case of the welded joint formed by butt welding shown in FIG. 2 as well, the fact that the steel sheets were joined by arc welding can be confirmed by the welded part extending in the direction vertical to the paper surface.

### <Chemical Composition of Steel Sheet>

First, the chemical composition of a base steel sheet of a plated steel sheet forming the welded joint will be explained. Below, the “%” relating to the chemical composition will mean “mass %”. Further, in the numerical ranges in the chemical composition, numerical ranges expressed using “to” will mean ranges including the numerical values described before and after “to” as lower limit values and upper limit values.

### (C: 0.05 to 0.40%)

C (carbon) is an element securing the strength of steel. To obtain the 780 MPa or more tensile strength covered by the present invention, considering the balance with weldability and, further, to keep the C concentration of the surface layer of the steel sheet from becoming too high, the content of C is made 0.05 to 0.40%. If the content of C is too large, even with the later explained high dew point annealing, the C concentration of the steel sheet surface layer will no longer become low. The content limit of C may be 0.07% or more, 0.10% or more, or 0.12% or more. The content of C may also be 0.35% or less, 0.30% or less, or 0.25% or less.

(Si: 0.7 to 3.0%, Sol. Al: 0.2 to 2.0%, Si+Sol. Al 1.0%)

Si (silicon) is an element promoting ferrite stabilization and decarburization by composite addition with Al (aluminum). To obtain the effect of improvement of LME resistance, Si: 0.7 to 3.0% and sol. Al: 0.2 to 2.0% are included and further the total value of the contents of Si and sol. Al is made 1.0% or more. “sol. Al” means the acid soluble Al not becoming an oxide such as Al₂ O₃ and able to dissolve in an acid. It is found as the Al measured after excluding the undissolved residue on filter paper formed in the process of analysis of Al. The content of Si may be 0.8% or more, 0.9% or more, or 1.0% or more. The content of Si may be 2.8% or less, 2.5% or less, or 2.0% or less. The content of sol. Al may be 0.3% or more, 0.4% or more, or 0.5% or more. The content of sol. Al may also be 1.8% or less, 1.6% or less, or 1.5% or less. The total value of the contents of Si and sol. Al may be 1.2% or more, 1.4% or more, 1.6% or more, or 1.8% or more.

### (Mn: 0.1 to 5.0%)

Mn (manganese) is an element effective for improving the strength of steel by obtaining hard structures. Considering the balance of the strength of steel and drop in formability by Mn segregation, the content of Mn is made 0.1 to 5.0%. The content of Mn may be 0.5% or more, 1.0% or more, or 1.5% or more. The content of Mn may also be 4.5% or less, 4.0% or less, or 3.5% or less.

### (P: 0.0300% or Less)

P (phosphorus) is an impurity generally contained in steel. With a content of P of more than 0.0300%, the weldability is liable to fall. Therefore, the content of P is made 0.0300% or less. The content of P may be 0.0200% or less, 0.0100% or less, or 0.0050% or less. It is preferable that P not be included, so the lower limit of the content of P is 0%. From the viewpoint of dephosphorization costs, the content of P may be more than 0%, 0.0001% or more, or 0.0005% or more.

### (S: 0.0300% or Less)

S (sulfur) is an impurity generally contained in steel. With a content of S of more than 0.0300%, the weldability falls. Further, the amount of precipitation of MnS increases and the bendability and other formability is liable to fall. Therefore, the content of S is made 0.0300% or less. The content of S may also be 0.0100% or less, 0.0050% or less, 0.0030% or less, 0.0020% or less, or 0.0010% or less. It is preferable that S not be included, so the lower limit of the content of S is 0%. From the viewpoint of the desulfurization costs, the content of S may be more than 0%, 0.0001% or more, or 0.0005% or more.

### (N: 0.0100% or Less)

N (nitrogen) is an impurity generally contained in steel. With a content of N of more than 0.0100%, the weldability is liable to fall. Therefore, the content of N is made 0.0100% or less. The content of N may also be 0.0080% or less, 0.0050% or less, 0.0030% or less, 0.0020% or less, or 0.0010% or less. It is preferable that N not be included, so the lower limit of the content of N is 0%. From the viewpoint of the production costs, the content of N may be more than 0%, 0.0001% or more, 0.0002% or more, 0.0003% or more, or 0.0005% or more.

### (B: 0 to 0.010%)

B (boron) is an element raising the hardenability and contributing to improvement of the strength and, further, segregating at the grain boundaries to strengthen the grain boundaries and improve the toughness, so may be included in accordance with need. It is not an essential element, so the lower limit of the content of B is 0%. This effect is also obtained by inclusion in a trace amount, but the content of B when included is preferably 0.00010% or more. The content of B may also be 0.0002% or more, 0.0003% or more, 0.0005% or more, 0.0007% or more, or 0.0010% or more. On the other hand, from the viewpoint of securing sufficient toughness, the content of B is made 0.010% or less. The content of B may also be 0.0080% or less, 0.0060% or less, 0.0050% or less, 0.0040% or less, or 0.0030% or less.

### (Ti: 0 to 0.150%)

Ti (titanium) is an element precipitating as TiC during cooling of the steel and contributing to improvement of the strength, so may be included in accordance with need. It is not an essential element, so the lower limit of the content of Ti is 0%. This effect is also obtained by inclusion in a trace amount, but the content of Ti when included is preferably 0.00010% or more. The content of Ti may be 0.0002% or more, 0.0003% or more, 0.0005% or more, 0.0007% or more, or 0.0010% or more. On the other hand, if excessively included, coarse TiN is formed and the toughness is liable to be impaired, so the content of Ti is made 0.150% or less. The content of Ti may also be 0.1000% or less, 0.0500% or less, 0.0300% or less, 0.0200% or less, 0.0100% or less, 0.0050% or less, or 0.0030% or less.

### (Nb: 0 to 0.150%)

Nb (niobium) is an element contributing to improvement of strength through improvement of the hardenability, so may be included in accordance with need. It is not an essential element, so the lower limit of the content of Nb is 0%. This effect is also obtained by inclusion in a trace amount, but the content of Nb when included is preferably 0.001% or more. The content of Nb may be 0.002% or more, 0.003% or more, 0.005% or more, or 0.008% or more. On the other hand, from the viewpoint of securing sufficient toughness, the content of Nb is made 0.150% or less. The content of Nb may also be 0.100% or less, 0.060% or less, 0.050% or less, 0.040% or less, or 0.030% or less.

### (V: 0 to 0.150%)

V (vanadium) is an element contributing to improvement of strength through improvement of hardenability, so may be included in accordance with need. It is not an essential element, so the lower limit of the content of V is 0%. This effect is also obtained by inclusion in a trace amount, but the content of V when included is preferably 0.0010% or more. The content of V may be 0.002% or more, 0.003% or more, or 0.005% or more. On the other hand, from the viewpoint of securing sufficient toughness, the content of V is made 0.150% or less. The content of V may also be 0.100% or less, 0.060% or less, 0.050% or less, 0.040% or less, 0.030% or less, or 0.020% or less.

### (Cr: 0 to 2.00%)

Cr (chromium) is an element effective for raising the hardenability of steel to raise the strength of steel, so may be included in accordance with need. It is not an essential element, so the lower limit of the content of Cr is 0%. This effect is also obtained by inclusion in a trace amount, but the content of Cr when included is preferably 0.001% or more. The content of Cr may be 0.01% or more, 0.02% or more, 0.03% or more, 0.05% or more, or 0.08% or more. On the other hand, if excessively included, Cr carbides are formed in large amounts and conversely the hardenability is liable to be impaired, so the content of Cr is made 2.00% or less. The content of Cr may be 1.80% or less, 1.50% or less, 1.20% or less, 1.00% or less, 0.70% or less, 0.50% or less, or 0.30% or less.

### (Ni: 0 to 2.00%)

Ni (nickel) is an element effective for raising the hardenability of steel to raise the strength of steel, so may be included in accordance with need. It is not an essential element, so the lower limit of the content of Ni is 0%. This effect is also obtained by inclusion in a trace amount, but the content of Ni when included is preferably 0.0010% or more. The content of Ni may be 0.010% or more or 0.02% or more. On the other hand, excessive addition of Ni causes the cost to rise, so the content of Ni is made 2.00% or less. The content of Ni may be 1.80% or less, 1.50% or less, 1.20% or less, 1.00% or less, 0.80% or less, 0.50% or less, 0.30% or less, 0.20% or less, 0.10% or less, or 0.05% or less

### (Cu: 0 to 2.00%)

Cu (copper) is an element effective for raising the hardenability of steel to raise the strength of steel, so may be included in accordance with need. It is not an essential element, so the lower limit of the content of Cu is 0%. This effect is also obtained by inclusion in a trace amount, but the content of Cu when included is preferably 0.0001% or more. The content of Cu may be 0.0002% or more, 0.0003% or more, or 0.0005% or more. On the other hand, from the viewpoint of suppressing a drop in toughness or cracking of the slab after casting, the content of Cu is made 2.00% or less. The content of Cu may also be 1.8000% or less, 1.5000% or less, 1.2000% or less, 1.0000% or less, 0.5000% or less, 0.1000% or less, 0.0500% or less, 0.0100% or less, 0.0050% or less, 0.0030% or less, or 0.0020% or less.

### (Mo: 0 to 1.00%)

Mo (molybdenum) is an element effective for raising the hardenability of steel to raise the strength of steel, so may be included in accordance with need. It is not an essential element, so the lower limit of the content of Mo is 0%. This effect is also obtained by inclusion in a trace amount, but the content of Mo when included is preferably 0.0010% or more. The content of Mo may be 0.01% or more, 0.02% or more, 0.03% or more, 0.05% or more, or 0.08% or more. On the other hand, from the viewpoint of suppressing a drop in toughness, the content of Mo is made 1.00% or less. The content of Mo may also be 0.90% or less, 0.70% or less, 0.50% or less, or 0.30% or less.

### (W: 0 to 1.00%)

W (tungsten) is an element effective for raising the hardenability of steel to raise the strength of steel, so may be included in accordance with need. It is not an essential element, so the lower limit of the content of W is 0%. This effect is also obtained by inclusion in a trace amount, but the content of W when included is preferably 0.0010% or more. The content of W may be 0.002% or more, 0.005% or more, or 0.01% or more. On the other hand, from the viewpoint of suppressing a drop in toughness, the content of W is made 1.00% or less. The content of W may also be 0.90% or less, 0.70% or less, 0.50% or less, 0.30% or less, 0.10% or less, 0.05% or less, or 0.03% or less.

### (Ca: 0 to 0.100%)

Ca (calcium) is an element contributing to control of inclusions, in particular fine dispersion of inclusions, and having the action of raising the toughness, so may be included in accordance with need. It is not an essential element, so the lower limit of the content of Ca is 0%. This effect is also obtained by inclusion in a trace amount, but the content of Ca when included is preferably 0.0001% or more. The content of Ca may be 0.0002% or more. On the other hand, if excessively included, deterioration of the surface properties sometimes appears, so the content of Ca is made 0.100% or less. The content of Ca may also be 0.0800% or less, 0.0500% or less, 0.0100% or less, 0.0050% or less, 0.0030% or less, 0.0020% or less, 0.0010% or less, 0.0008% or less, or 0.0005% or less.

### (Mg: 0 to 0.100%)

Mg (magnesium) is an element contributing to control of inclusions, in particular fine dispersion of inclusions, and having the action of raising the toughness, so may be included in accordance with need. It is not an essential element, so the lower limit of the content of Mg is 0%. This effect is also obtained by inclusion in a trace amount, but the content of Mg when included is preferably 0.0001% or more. The content of Mg may be 0.0002% or more, 0.0003% or more, 0.0005% or more, or 0.0008% or more. On the other hand, if excessively included, deterioration of the surface properties sometimes appears, so the content of Mg is made 0.100% or less. The content of Mg may be 0.090% or less, 0.080% or less, 0.050% or less, 0.010% or less, 0.005% or less, or 0.003% or less.

### (Zr: 0 to 0.100%)

Zr (zirconium) is an element contributing to control of inclusions, in particular fine dispersion of inclusions, and having the action of raising the toughness, so may be included in accordance with need. It is not an essential element, so the lower limit of the content of Zr is 0%. This effect is also obtained by inclusion in a trace amount, but the content of Zr when included is preferably 0.001% or more. The content of Zr may be 0.002% or more, 0.003% or more, 0.005% or more, or 0.010% or more. On the other hand, if excessively included, deterioration of the surface properties sometimes appears, so the content of Zr is made 0.100% or less. The content of Zr may be 0.080% or less, 0.050% or less, 0.040% or less, or 0.030% or less.

### (Hf: 0 to 0.100%)

Hf (hafnium) is an element contributing to control of inclusions, in particular fine dispersion of inclusions, and having the action of raising the toughness, so may be included in accordance with need. It is not an essential element, so the lower limit of the content of Hf is 0%. This effect is also obtained by inclusion in a trace amount, but the content of Hf when included is preferably 0.0001% or more. The content of Hf may be 0.0002% or more, 0.0003% or more, 0.0005% or more, or 0.0008% or more. On the other hand, if excessively included, deterioration of the surface properties sometimes appears, so the content of Hf is made 0.100% or less. The content of Hf may be 0.050% or less, 0.030% or less, 0.010% or less, 0.005% or less, or 0.003% or less.

### (REM: 0 to 0.100%)

An REM (rare earth element) is an element contributing to control of inclusions, in particular fine dispersion of inclusions, and having the action of raising the toughness, so may be included in accordance with need. It is not an essential element, so the lower limit of the content of an REM is 0%. This effect is also obtained by inclusion in a trace amount, but the content of an REM when included is preferably 0.0001% or more. The content of an REM may be 0.0003% or more or 0.0005% or more. On the other hand, if excessively included, deterioration of the surface properties sometimes appears, so the content of an REM is made 0.100% or less. The content of an REM may be 0.0500% or less, 0.0300% or less, 0.0100% or less, 0.0050% or less, 0.0030% or less, or 0.0020% or less. Note that, “REM” is an abbreviation for “rare earth metal” and means elements belonging to the lanthanoids. An REM is usually added as a mischmetal.

In a steel sheet forming the welded joint according to the present invention, the balance besides the above chemical composition is comprised of Fe and impurities. Here, “impurities” mean constituents which enter due to various factors in the production process, first and foremost the raw materials such as ore and scrap, when industrially producing steel sheet and which do not have a detrimental effect on the LME resistance at the time of production of the welded joint according to the present invention.

The chemical composition of the steel sheet may be analyzed using any element analysis method known to a person skilled in the art, for example, inductively coupled plasma-mass spectroscopy (ICP-MS). However, C and S may be measured using the combustion-infrared absorption method, and N may be measured using the inert gas melting-thermal conductivity method. These analyses may be performed by samples taken from the steel sheet by the method based on JIS G0417: 1999.

The plated steel sheet forming the welded joint of the present invention is provided with a plating layer formed at least on the surface corresponding to part of the non-heat affected zone at the time of welding among the base steel sheet and the surface of the base steel sheet. The plating layer is not particularly limited so long as containing Zn. As one example, Zn-0.2% Al, Zn-0.5% Al, Zn-1.5% Al-1.5% Mg, Zn-20% Al-7% Mg, and Zn-30% Al-10% Mg may be mentioned. The plating layer may also be formed at other than the surface corresponding to an overlaid surface of the non-heat affected zone.

The chemical composition in the plating layer can be determined by dissolving the plating layer in an acid solution containing an inhibitor for suppressing corrosion of the steel sheet and measuring the obtained solution by ICP (high frequency inductively coupled plasma) emission spectroscopy. The acid solution containing the inhibitor may, for example, be a 10 mass % hydrochloric acid solution containing 0.06 mass % of an inhibitor (Ibit made by Asahi Chemicals Co., Ltd.)

The thickness of the plating layer may be, for example, 3 to 50 μm. Further, the amount of deposition of the plating layer is not particularly limited, but, for example, may be 10 to 170 g/m² per surface. In the present invention, the amount of deposition of the plating layer is determined by dissolving the plating layer in an acid solution containing an inhibitor for suppressing corrosion of the base steel sheet and measuring the change in weight before and after removal of the plating layer by the acid wash. The thickness of the plating layer may be 5 μm or more, 10 μm or more, 15 μm or more, or 20 μm or more. The thickness of the plating layer may also be 40 μm or less or 30 μm or less. The amount of deposition of the plating layer may be, per surface, 20 g/m² or more, 30 g/m² or more, 40 g/m² or more, or 50 g/m² or more. The amount of deposition of the plating layer may also be, per surface, 150 g/m² or less, 130 g/m² or less, 120 g/m² or less, or 100 g/m² or less.

The sheet thicknesses of the steel sheet forming the welded joint of the present invention are not particularly limited. For example, they may be made 0.6 to 3.2 mm. The sheet thicknesses may be 0.8 mm or more or 1.0 mm or more. The sheet thicknesses may be 3.0 mm or less, 2.6 mm or less, 2.4 mm or less, 2.2 mm or less, 2.0 mm or less, or 1.8 mm or less.

### <Structure of Steel Sheet Forming Welded Joint>

Next, the structure of a steel sheet forming the welded joint will be explained.

### [C Concentration of Non-Heat Affected Zone]

In the welded joint of the present invention, the depth with a C concentration measured by GDS of 0.05% or less in the depth direction of the base steel sheet starting from the interface of the plating layer and base steel sheet at the non-heat affected zone of the steel sheet is 5 μm or more. The heat affected zone is a part changing in material properties due to heat in the process of arc welding and can be confirmed by SEM observation. The non-heat affected zone is a part other than the heat affected zone.

The LME sensitivity falls if the C concentration becomes lower, so by lowering the C concentration of the non-heat affected zone, the LME resistance at the time of production of the welded joint is improved.

Such a structure can be obtained by making the chemical composition of the steel sheet, as explained above, constituents in which Si and Al are included in large amounts, performing the later explained heat treatment, and performing arc welding.

If the depth with a C concentration of 0.05% or less is 5 μm or more, the effect of improvement of the LME resistance at the time of production is obtained, so the upper limit of the depth is not particularly prescribed. For example, the depth may be 50 μm or less, 40 μm or less, or 30 μm or less. The depth with a C concentration of 0.05% or less is preferably 7 μm or more, 8 μm or more, 10 μm or more, or 12 μm or more, preferably is 15 μm or more.

The GDS measurement is performed five times in the sheet thickness direction. The average value of the measurements is made the C concentration. The measurement conditions are as explained below: The starting point of the “depth” is the interface of the base steel sheet and the plating layer. The interface of the base steel sheet and plating layer is made the position where the concentration of Fe measured by GDS measurement becomes 93% of the concentration of Fe at the depth of 150 μm.
Apparatus: high frequency glow discharge optical emission spectrometry (made by LECO Japan, model “GDS850A”)
Ar gas pressure: 0.3 MPa
Anode diameter: 4 mmφ
RF output: 30 W
Measurement time: 200 to 1500 seconds

### [Interface Roughness at Non-Heat Affected Zone]

In the welded joint of the present invention, the roughness of the interface of the plating layer and base steel sheet of the steel sheet at the non-heat affected zone is an arithmetic average height Ra defined by JIS B0601: 2013 of 3.0 μm or less. If the roughness becomes larger, stress concentration causes cracking to easily occur. The roughness of the interface may be an Ra of 2.5 μm or less or 2.0 μm or less. The interface roughness may be deemed the surface roughness of the steel sheet measured after removing the plating. The plating is removed by dissolving the plating layer in an acid solution to which an inhibitor suppressing corrosion of steel sheet is added.

### [C Concentration of Outside of Bead Toe]

In the welded joint of the present invention, the C concentration at a depth of 5 μm of the base steel sheet starting from the interface of the plating layer of the steel sheet and the base steel sheet in the range of 0 to 100 μm from the bead toe of the welded part to the opposite direction from the welded part (direction vertical to weld boundary and away from welded part) is 0.05% or less.

The LME sensitivity falls if the C concentration becomes lower, so by lowering the C concentration of the bead toe of the welded part, the LME resistance at the time of production of the welded joint is improved.

Further, in a range of 0 to 100 μm from a bead toe of the welded part to an opposite direction from the welded part, a C concentration at a depth of 5 μm of the base steel sheet starting from an interface of the plating layer and the base steel sheet of the steel sheet being 0.02% or less is preferable from the viewpoint of improvement of the LME resistance. A C concentration at a depth of 5 μm of the base steel sheet starting from an interface of the plating layer and the base steel sheet of the steel sheet in the range of 0 to 100 μm in the opposite direction from the welded part being 0.010% or less is more preferable

The C concentration is measured by SEM-EPMA. The measurement method is as follows: An examined sample is cut out from the welded joint so as to include a range of 0 to 100 μm to the outside of the bead toe. The cross-section in the thickness direction of the steel sheet is polished to a mirror surface. Next, the polished examined sample is point analyzed by the calibration curve method using EPMA. “Point analysis” is quantitative analysis with a measurement range made a diameter of 0 μm in the settings. As the EPMA apparatus, for example, JXA-8500 made by JEOL can be used. The analysis conditions of EPMA are an acceleration voltage of 15 kV, an emission current of 5×10⁻⁷ A. The magnification is made 5000×. A calibration curve is prepared by forming Fe-0.01% C, Fe-0.05% C, and Fe-0.10% C alloys and measuring the average C concentration of the alloys under the above conditions.

The measurement by point analysis is performed in 5 μm increments in the range of 0 to 100 μm outside of the bead toe for a position of a depth of 5 μm starting from the plating layer and base steel sheet of the steel plate. The average value of the measurement values at the different positions is made the C concentration at a depth of 5 μm in the range of 0 to 100 μm in the opposite direction from the welded part.

### [Tensile Strength of Steel Sheet]

The present invention suppresses the LME which occurs in high strength steel sheet, so the steel sheet forming the welded joint is high in strength. Specifically, it has a 780 MPa or more tensile strength. The upper limit of the tensile strength is not particularly prescribed, but from the viewpoint of securing toughness, for example, it may be 2000 MPa or less. The tensile strength may be measured by taking a JIS No. 5 tensile test piece having a direction orthogonal to the rolling direction as its longitudinal direction and subjecting it to JIS Z 2241: 2011. The tensile strength may be 880 MPa or more, 980 MPa or more, 1080 MPa or more, or 1180 MPa or more. The tensile strength may also be 1900 MPa or less or 1800 MPa or less.

Note that when a test piece for tensile strength measurement cannot be obtained from the steel sheet forming a welded joint, alternatively it is possible to measure the hardness (Vickers hardness) of the steel sheet at the non-heat affected zone at a distance 5 mm or more away from the outer end of the spot welded part and estimate the value of the tensile strength from the following relationship (Relationship Between Static Strength Parameters, Fumihiko Hasegawa, Junichi Arai, Tsuneshichi Tanaka, “Materials”, Vol. 39, No. 442, P859-863)∘

$$Hv = 0.301 \times TS + 5.701$$

(where, Hv is the Vickers hardness and TS is the tensile strength (unit: MPa).

That is, if the hardness is 240 Hv or so or more, the tensile strength may be deemed to be 780 MPa or more.

The hardness of the steel sheet is measured at a position of a non-heat affected zone of the steel sheet forming the welded joint at a position of ½ depth. The hardness is measured based on JIS Z 2244: 2009. The measurement load is made 200 gf. The hardness of the steel sheet at the non-heat affected zone at a distance of 5 mm or more away from the outer end of the spot welded part may be 245 Hv or more, 250 Hv or more, 260 Hv or more, 270 Hv or more, 300 Hv or more, or 340 Hv or more.

Next, the method of production of the welded joint according to the present invention will be explained. First, the method of production of a steel sheet forming the welded joint will be explained.

A steel sheet forming the welded joint according to the present invention can, for example, be obtained by a method of production provided with a casting step of casting molten steel adjusted in chemical composition to form a steel slab, a hot rolling step of hot rolling the steel slab to obtain hot rolled steel sheet, a coiling step of coiling the hot rolled steel sheet, a cold rolling step of cold rolling the coiled hot rolled steel sheet to obtain a cold rolled steel sheet, a pretreatment step of brush grinding the cold rolled steel sheet, and an annealing step of annealing the treated cold rolled steel sheet. Alternatively, it is also possible to not perform coiling after the hot rolling step but to perform pickling then cold rolling in that state.

### [Casting Step]

The conditions of the casting step are not particularly limited. For example, it is sufficient to cast the steel by melting it in a blast furnace or electric arc furnace etc., then performing various secondary refining processes, then performing the usual continuous casting, casting by the ingot method, etc. or other method.

### [Hot Rolling Step]

The steel slab obtained by the casting can be hot rolled to obtain hot rolled steel sheet. The hot rolling step is performed by hot rolling the cast steel slab directly or after reheating after cooling it once. If reheating, the heating temperature of the steel slab may be, for example, 1100 to 1250° C. In the hot rolling step, usually rough rolling and finish rolling are performed. The temperatures and reduction rates of the rolling processes may be suitably changed in accordance with the desired microstructure and sheet thickness. For example, the end temperature of the finish rolling may be 900 to 1050° C. and the reduction rate of the finish rolling may be 10 to 50%.

### [Coiling Step]

The hot rolled steel sheet can be coiled at a predetermined temperature. The coiling temperature may be suitably changed in accordance with the desired microstructure etc. For example, it may be 500 to 800° C. Predetermined heat treatment may be applied to the hot rolled steel sheet before coiling or after coiling. Alternatively, the steel sheet need not be coiled, but can be pickled then cold rolled as explained later after the hot rolling step.

### [Cold Rolling Step]

After the hot rolled steel sheet is pickled etc., the hot rolled steel sheet can be cold rolled to obtain cold rolled steel sheet. The reduction rate in the cold rolling may be suitably changed in accordance with the desired microstructure and sheet thickness. For example, it may be 20 to 80%. After the cold rolling step, for example, the steel sheet may be air cooled to cool it down to room temperature.

### [Pretreatment Step]

As explained above, it is necessary to perform predetermined pretreatment before annealing the steel sheet and then perform the annealing so that, at the welded joint, so that a depth with a C concentration measured by GDS of 0.05% or less in a depth direction of the base material starting from an interface of the plating layer and the base steel sheet at the non-heat affected zone of the steel sheet becomes 5 μm or more and, in a range of 0 to 100 μm from a bead toe of the welded part to an opposite direction from the welded part, a C concentration at a depth of 5 μm of the base steel sheet starting from an interface of the plating layer and the base steel sheet of the steel sheet becomes 0.05% or less.

The pretreatment includes using a brush roll to grind down the cold rolled steel sheet surface (brushing treatment). As the brush roll which can be used, for example, M-33 made by Hotani Co., Ltd. may be mentioned. Due to this, strain can be introduced without making the roughness of the surface greater. At the time of grinding, the steel sheet surface may be coated with an NaOH 1.0 to 5.0% aqueous solution. The brushing reduction may be made 0.5 to 10.0 mm and the speed 100 to 1000 rpm. By controlling the coating solution conditions, brushing reduction, and speed in performing the brushing treatment, decarburization is promoted in the annealing step explained below, a stable ferrite structure can be efficiently formed at the surface layer of the steel sheet, and a low C concentration can be maintained around the welded part at the time of production of a welded joint.

### [Annealing Step]

After the pretreatment step, the cold rolled steel sheet is annealed. The annealing is, for example, performed in a state applying 1 to 20 MPa tension. If applying tension at the time of annealing, it becomes possible more effectively introduce strain to the steel sheet and decarburization of the surface layer is promoted.

The holding temperature of the annealing step is made 750 to 900° C. The holding temperature may also be 770 to 870° C. By making it such a range, it is possible to promote decarburization, reduce the C concentration of the surface layer, and stabilize the ferrite phase. The rate of temperature rise up to the holding temperature is not particularly limited, but may be 1 to 10° C./s.

The holding time at the holding temperature of the annealing step is made 20 to 300 seconds. The holding time may be between 30 to 250 seconds. By making it such a range, it is possible to promote decarburization, reduce the C concentration of the surface layer, and stabilize the ferrite phase.

The atmosphere of the annealing step is made the dew point-30 to 20° C. The dew point may also be −10 to 5° C. The atmosphere, for example, may also be N₂ −1 to 10 vol % H₂, N₂ −2 to 4 vol % H₂. If the dew point is too high or too low, a phase containing Si, Mn, Al, and other oxides is formed at the outside of the steel sheet. Furthermore, sometimes mutual diffusion of the plating constituents and steel constituents is obstructed and the plateability becomes insufficient.

Due to the method of production provided with the above-mentioned steps, it is possible to obtain steel sheet wherein decarburization is promoted in the surface layer of the steel sheet, the ferrite phase is stabilized, and a low C concentration can be maintained around the welded part at the time of production of a welded joint.

### <Method of Production of Plated Steel Sheet>

The plated steel sheet forming the welded joint according to the present invention can be obtained by plating for forming a plating layer containing zinc on the steel sheet produced as explained above.

The plating may be performed by a method known to persons skilled in the art. The plating may for example be performed by hot dip coating and may be performed by electroplating. Preferably, the plating is performed by hot dip coating. The conditions of the plating may be suitably set considering the chemical composition, thickness, amount of deposition, etc. of the desired plating layer. For example, the steel sheet may be dipped in a 420 to 480° C. hot dip galvanization bath adjusted in chemical composition for 1 to 10 seconds, pulled out after dipping at 20 to 200 mm/s, and wiped by N₂ gas to control the amount of plating deposition. After plating, alloying may be performed. The alloying may for example be performed at 500 to 550° C. for 10 to 60 seconds.

### <Arc Welding Step>

Two of each of the steel sheets were overlaid or made to abut and are arc welded to obtain a weld joint. The welding conditions of the arc welding and the wire used are not particularly limited. For example, the arc welding can be performed by an weld current of 80 to 300 A, weld voltage 15 to 35V, and weld speed 50 to 200 cm/min and weld gas 10 to 30% CO₂+Ar, flow rate: 10 to 30 L/min.

The welded joint according to the present invention is suppressed in LME cracking at the time of production, so can be suitably used in automobiles, household electrical appliances, building materials, and other broad fields. In particular, it is preferably used in the automotive field.

### EXAMPLES

Below, examples will be used to explain the present invention in more detail. The present invention is not limited to these examples.

### Example 1

### (Preparation of Steel Sheet Samples)

Molten steel adjusted to the chemical composition described in No. 1 of Table 1 was smelted in a blast furnace and cast by continuous casting to obtain a steel slab. The obtained steel slab was heated to 1200° C. and hot rolled by an end temperature of finish rolling of 950° C. and a reduction rate of the finish rolling of 30% to obtain hot rolled steel sheet. The obtained hot rolled steel sheet was coiled at the coiling temperature of 650° C., was pickled, then was cold rolled by a reduction rate of 50% to obtain cold rolled steel sheet. The sheet thickness of the cold rolled steel sheet was 1.6 mm.

Next, the cold rolled steel sheet was coated with an NaOH 2.0% aqueous solution and brushed as pretreatment. The brushing was performed using as a brushing roll the M-33 made by Hotani Co., Ltd. at a brushing reduction of 2.0 mm and speed of 600 rpm (Condition A of Table 2).

Before the annealing step, the surface roughness of the steel sheet was measured based on JIS B 0601: 2013. That is, 10 locations at the surface of the surface layer part side were randomly selected and the respective locations were measured for surface profiles by a contact type surface roughness meter. The surface roughnesses at these locations were averaged. The arithmetic average roughness Ra was evaluated as follows:
Evaluation AA: 2.0 μm or less
Evaluation A: more than 2.0 μm and 3.0 μm or less
Evaluation B: more than 3.0 μm

After that, the steel sheet was annealed at a dew point of 0° C., a holding temperature of 800° C., and a holding time of 20 seconds inside a furnace with an oxygen concentration of 20 ppm or less in an N₂ −4% H₂ gas atmosphere to prepare a steel sheet sample. The rate of temperature rise at the time of annealing was made 6.0° C./s up to 500° C. and 2.0° C./s from 500° C. to the holding temperature. The annealing treatment was performed in a state applying 15 MPa tension.

After the annealing, the steel sheet was plated to obtain hot dip galvanized steel sheet. The plating was performed by dipping in a 460° C. hot dip galvanization bath (Zn-0.2% Al) for 3 seconds. After dipping, the steel sheet was pulled out at 100 mm/s and was controlled in plating deposition amount to 50 g/m² by N₂ wiping gas.

### Examples 2 to 28 and Comparative Examples 29 to 41

Except for making the chemical composition those described in Table 1, making the conditions of the pretreatment steps and the annealing steps those described in Table 2, and making the plating types those described in Table 3, the same procedures were followed as in Example 1 to produce steel sheets. Note that, in No. 40, pretreatment by brushing was omitted. Further, in No. 41, a D-100 brushing roll made by Hotani Co., Ltd. (Condition B of Table 2) was used. D-100 is a roll with a grinding amount 2 times greater than M-33.

The composition of the type of plating and the bath temperature shown in Table 3 were as follows: F was made plating, then alloying at 530° C. for 20 seconds to perform hot dip galvannealing.
A: Zn-0.2% Al (460° C.)
B: Zn-0.5% Al (440° C.)
C: Zn-1.5% Al-1.5% Mg (500° C.)
D: Zn-20% Al-7% Mg (530° C.)
E: Zn-30% Al-10% Mg (530° C.)
F: Zn-0.14% Al (450° C.)
hot dip galvannealing

TABLE 1

| | | Chemical composition (mass %), balance: Fe and impurities | | | | | | | | | | |
|---|---|---|---|---|---|---|---|---|---|---|---|---|
| No. | Class | C | Si | Mn | sol.Al | P | S | N | B | Ti | Others | Si + sol.Al |
| 1 | Ex. | 0.05 | 0.8 | 2.0 | 0.2 | 0.0001 | 0.0008 | 0.0007 | | | | 1.0 |
| 2 | Ex. | 0.10 | 0.9 | 2.0 | 0.5 | 0.0080 | 0.0003 | 0.0002 | 0.0005 | 0.0002 | | 1.4 |
| 3 | Ex. | 0.10 | 0.9 | 2.2 | 0.7 | 0.0080 | 0.0008 | 0.0007 | 0.0002 | 0.0006 | Hf: 0.001 | 1.6 |
| 4 | Ex. | 0.10 | 1.2 | 2.2 | 1.0 | 0.0070 | 0.0005 | 0.0004 | 0.0002 | 0.0001 | | 2.2 |
| 5 | Ex. | 0.10 | 0.9 | 2.2 | 0.8 | 0.0020 | 0.0003 | 0.0003 | 0.0003 | 0.0009 | Mg: 0.001 | 1.7 |
| 6 | Ex. | 0.20 | 1.0 | 2.0 | 1.0 | 0.0100 | 0.0002 | 0.0009 | 0.0009 | 0.0003 | | 2.0 |
| 7 | Ex. | 0.20 | 0.9 | 2.0 | 1.0 | 0.0020 | 0.0010 | 0.0002 | 0.0005 | 0.0001 | Zr: 0.015 | 1.9 |
| 8 | Ex. | 0.20 | 0.8 | 2.2 | 0.2 | 0.0008 | 0.0009 | 0.0006 | 0.0006 | 0.0008 | Cr: 0.1 | 1.0 |
| 9 | Ex. | 0.20 | 1.0 | 2.5 | 1.0 | 0.0017 | 0.0003 | 0.0002 | 0.0002 | 0.0006 | Ni: 0.02 | 2.0 |
| 10 | Ex. | 0.20 | 1.0 | 2.3 | 0.8 | 0.0011 | 0.0002 | 0.0001 | 0.0003 | 0.0007 | Cu: 0.0007 | 1.8 |
| 11 | Ex. | 0.20 | 1.0 | 2.3 | 1.0 | 0.0031 | 0.0004 | 0.0007 | 0.0003 | 0.0009 | Zr: 0.015 | 2.0 |
| 12 | Ex. | 0.20 | 1.0 | 2.5 | 1.0 | 0.0065 | 0.0007 | 0.0007 | 0.0003 | 0.0007 | | 2.0 |
| 13 | Ex. | 0.20 | 0.8 | 2.3 | 0.2 | 0.0040 | 0.0007 | 0.0009 | 0.0007 | 0.0007 | | 1.0 |
| 14 | Ex. | 0.20 | 0.8 | 2.3 | 0.2 | 0.0012 | 0.0004 | 0.0009 | 0.0009 | 0.0007 | | 1.0 |
| 15 | Ex | 0.25 | 1.0 | 2.2 | 1.0 | 0.0032 | 0.0005 | 0.0006 | 0.0008 | 0.0008 | | 2.0 |
| 16 | Ex. | 0.25 | 1.0 | 2.2 | 1.0 | 0.0012 | 0.0005 | 0.0005 | 0.0007 | 0.0008 | Nb: 0.010 | 2.0 |
| 17 | Ex. | 0.25 | 1.0 | 2.2 | 1.0 | 0.0040 | 0.0005 | 0.0006 | 0.0006 | 0.0009 | V: 0.007 | 2.0 |
| 18 | Ex. | 0.30 | 1.0 | 2.5 | 1.0 | 0.0099 | 0.0009 | 0.0010 | 0.0003 | 0.0006 | | 2.0 |
| 19 | Ex | 0.20 | 0.8 | 2.3 | 0.2 | 0.0031 | 0.0004 | 0.0002 | 0.0007 | 0.0007 | | 1.0 |
| 20 | Ex. | 0.20 | 0.8 | 2.5 | 0.2 | 0.0031 | 0.0004 | 0.0007 | 0.0005 | 0.0001 | | 1.0 |
| 21 | Ex. | 0.20 | 0.8 | 2.3 | 0.2 | 0.0031 | 0.0004 | 0.0009 | 0.0001 | 0.0007 | | 1.0 |
| 22 | Ex. | 0.30 | 1.0 | 0.3 | 0.8 | 0.0110 | 0.0007 | 0.0006 | 0.0003 | 0.0004 | | 1.8 |
| 23 | Ex. | 0.35 | 1.0 | 5.0 | 1.0 | 0.0092 | 0.0009 | 0.0005 | 0.0010 | 0.0003 | Mo: 0.1 | 2.0 |
| 24 | Ex. | 0.35 | 1.0 | 2.2 | 0.9 | 0.0091 | 0.0006 | 0.0006 | 0.0006 | 0.0006 | REM: 0.0006 | 1.9 |
| 25 | Ex. | 0.40 | 1.0 | 2.2 | 1.0 | 0.0045 | 0.0004 | 0.0004 | 0.0008 | 0.0010 | | 2.0 |
| 26 | Ex. | 0.40 | 1.0 | 2.2 | 1.0 | 0.0035 | 0.0009 | 0.0006 | 0.0004 | 0.0006 | W: 0.02 | 2.0 |
| 27 | Ex. | 0.40 | 1.0 | 2.2 | 1.0 | 0.0082 | 0.0002 | 0.0005 | 0.0003 | 0.0007 | Ca: 0.0002 | 2.0 |
| 28 | Ex. | 0.40 | 1.0 | 2.2 | 1.0 | 0.0080 | 0.0002 | 0.0003 | 0.0009 | 0.0003 | | 2.0 |
| 29 | Comp. ex. | 0.42 | 1.0 | 2.0 | 0.3 | 0.0100 | 0.0004 | 0.0003 | 0.0006 | 0.0008 | | 1.3 |
| 30 | Comp. ex. | 0.20 | 0.6 | 2.0 | 0.3 | 0.0100 | 0.0008 | 0.0008 | 0.0007 | 0.0008 | | 0.9 |
| 31 | Comp. ex. | 0.20 | 0.6 | 2.0 | 0.4 | 0.0099 | 0.0007 | 0.0006 | 0.0006 | 0.0007 | | 1.0 |
| 32 | Comp. ex. | 0.20 | 3.1 | 2.0 | 0.3 | 0.0091 | 0.0002 | 0.0003 | 0.0004 | 0.0004 | | 3.4 |
| 33 | Comp. ex. | 0.20 | 1.0 | 2.0 | 0.1 | 0.0088 | 0.0004 | 0.0001 | 0.0008 | 0.0004 | | 1.1 |
| 34 | Comp. ex. | 0.20 | 1.0 | 2.0 | 2.2 | 0.0100 | 0.0009 | 0.0001 | 0.0003 | 0.0003 | | 3.2 |
| 35 | Comp. ex. | 0.20 | 0.7 | 2.0 | 0.2 | 0.0085 | 0.0004 | 0.0008 | 0.0008 | 0.0001 | | 0.9 |
| 36 | Comp. ex. | 0.20 | 1.0 | 2.0 | 0.3 | 0.0100 | 0.0005 | 0.0004 | 0.0007 | 0.0006 | | 1.3 |
| 37 | Comp. ex. | 0.20 | 1.0 | 2.0 | 0.3 | 0.0100 | 0.0004 | 0.0007 | 0.0005 | 0.0009 | | 1.3 |
| 38 | Comp. ex. | 0.20 | 1.0 | 2.0 | 0.3 | 0.0100 | 0.0004 | 0.0005 | 0.0002 | 0.0007 | | 1.3 |
| 39 | Comp. ex. | 0.08 | 1.0 | 2.0 | 0.3 | 0.0100 | 0.0005 | 0.0009 | 0.0003 | 0.0007 | | 1.3 |
| 40 | Comp. ex. | 0.20 | 1.0 | 2.0 | 0.3 | 0.0100 | 0.0004 | 0.0005 | 0.0004 | 0.0002 | | 1.3 |
| 41 | Comp. ex. | 0.20 | 1.0 | 2.0 | 0.3 | 0.0100 | 0.0003 | 0.0008 | 0.0001 | 0.0008 | | 1.3 |
| 42 | Comp. ex. | 0.20 | 1.0 | 2.0 | 0.3 | 0.0100 | 0.0009 | 0.0006 | 0.0007 | 0.0008 | | 1.3 |

* Underlines indicate outside scope of present invention

TABLE 2

| | | Pretreatment step | | Annealing step | | |
|---|---|---|---|---|---|---|
| | | | Surface | Holding | Holding | Dew |
| | | | roughness of | temp. | time | point |
| No. | Class | Condition | plated steel sheet | (° C.) | (s) | (° C.) |
| 1 | Ex. | A | A | 800 | 20 | 0 |
| 2 | Ex. | A | A | 800 | 50 | 0 |
| 3 | Ex. | A | A | 800 | 220 | 0 |
| 4 | Ex. | A | A | 820 | 50 | 0 |
| 5 | Ex. | A | AA | 840 | 100 | 0 |
| 6 | Ex | A | AA | 860 | 80 | 0 |
| 7 | Ex. | A | AA | 860 | 100 | 0 |
| 8 | Ex. | A | AA | 860 | 100 | 0 |
| 9 | Ex. | A | AA | 860 | 100 | 0 |
| 10 | Ex | A | AA | 860 | 100 | 0 |
| 11 | Ex. | A | AA | 860 | 20 | 0 |
| 12 | Ex. | A | AA | 860 | 100 | 0 |
| 13 | Ex. | A | A | 900 | 20 | 0 |
| 14 | Ex. | A | A | 750 | 50 | 0 |
| 15 | Ex. | A | AA | 780 | 160 | 0 |
| 16 | Ex. | A | AA | 860 | 100 | 0 |
| 17 | Ex. | A | AA | 860 | 40 | 0 |
| 18 | Ex. | A | AA | 860 | 100 | 0 |
| 19 | Ex. | A | A | 860 | 20 | 0 |
| 20 | Ex. | A | A | 860 | 20 | 0 |
| 21 | Ex. | A | A | 860 | 20 | 0 |
| 22 | Ex. | A | AA | 860 | 300 | 0 |
| 23 | Ex. | A | AA | 860 | 200 | 0 |
| 24 | Ex. | A | A | 860 | 200 | 0 |
| 25 | Ex. | A | AA | 860 | 200 | 0 |
| 26 | Ex. | A | AA | 860 | 200 | −20 |
| 27 | Ex. | A | AA | 860 | 200 | 0 |
| 28 | Ex. | A | AA | 860 | 200 | 0 |
| 29 | Comp. ex. | A | A | 800 | 60 | 0 |
| 30 | Comp. ex. | A | A | 800 | 60 | 0 |
| 31 | Comp. ex. | A | A | 800 | 60 | 0 |
| 32 | Comp. ex. | A | A | 800 | 60 | 0 |
| 33 | Comp. ex. | A | A | 800 | 60 | 0 |
| 34 | Comp. ex. | A | A | 800 | 60 | 0 |
| 35 | Comp. ex. | A | A | 800 | 60 | 0 |
| 36 | Comp. ex. | A | A | 800 | 60 | −40 |
| 37 | Comp. ex. | A | A | 800 | 60 | 30 |
| 38 | Comp. ex. | A | A | 720 | 60 | 0 |
| 39 | Comp. ex. | A | A | 920 | 60 | 0 |
| 40 | Comp. ex. | A | A | 800 | 10 | 0 |
| 41 | Comp. ex. | None | A | 800 | 60 | 0 |
| 42 | Comp. ex. | B | B | 800 | 60 | 0 |

* Underlines indicate outside scope of preferred method of production

### (Evaluation of Tensile Strength)

For each steel sheet, a JIS No. 5 tensile test piece having a direction at right angles to the rolling direction as its longitudinal direction was taken, a tensile test was conducted based on JIS Z 2241: 2011, the tensile strength was found, and the sheet was evaluated as follows:
Evaluation AAA: 1180 MPa or more
Evaluation AA: 980 MPa or more and less than 1180 MPa
Evaluation A: 780 MPa or more and less than 980 MPa

### (Evaluation of LME Resistance)

For each of the steel sheets, two of the same steel sheets were welded by gas metal arc welding to form a weld bead and thereby prepare a lap fillet welded joint. The effect of suppression of LME at the time of production (LME resistance) was evaluated. The welding conditions were as follows:
Weld current: 250 A
Weld voltage: 26.2V
Weld speed: 80 cm/min
Weld gas: 20% CO₂+Ar, flow rate: 20 L/min
Weld wire: YM-24T (φ1.2 mm)), made by Nippon Steel Welding & Engineering Co., Ltd.
Tilt angle of welding torch: 60°
Overlay: 10 mm
Steel sheet size: top sheet side 150×50 mm, bottom sheet side 150×30 mm
Sheet gap: 0 mm
Wire projecting length: 15 mm

The LME resistance was evaluated as follows by the length of LME cracking formed. If the evaluation is “A” or more, it was judged that the LME resistance was excellent and the technical problem of the present invention was solved.
Evaluation AAA: 0 μm
Evaluation AA: more than 0 μm and less than 60 μm
Evaluation A: 60 μm or more and less than 120 μm
Evaluation B: 120 μm or more

### (Evaluation of Structure in Vicinity of Welded Part)

The welded joint was cut to obtain a sample. This was measured by GDS five times in the sheet thickness direction at the position forming the non-heat affected zone starting from the interface of the plating layer and base steel sheet. The depth with a C concentration of 0.05% or less was found and shown in “C≤0.05% depth” of Table 3.

Further, at a position forming the non-heat affected zone, the plating was removed using a 10 mass % hydrochloric acid solution to which 0.06 mass % inhibitor (ibit made by Asahi Chemical Co., Ltd.) was added. The roughness of the surface of the exposed base steel sheet was measured by a method similar to that before the annealing and was shown in “base steel sheet/plating surface roughness” of Table 3.

Further, the C concentration at a depth of 5 μm of the base steel sheet starting from an interface of the plating layer of the steel sheet and the base steel sheet at a position of 0 to 100 μm from a bead toe on the bottom sheet side of the welded part to an opposite direction from the welded part was measured by SEM-EPMA and was shown in “C concentration” of Table 3. The method of measurement was as follows:

An examined sample is cut out from the welded joint so as to include a range of 0 to 100 μm from the bead toe in the opposite direction from the welded part. The cross-section in the thickness direction of the steel sheet was polished to a mirror surface. Next, the polished examined sample was point analyzed by the calibration curve method using EPMA. As the EPMA apparatus, JXA-8500 made by JEOL was used. The analysis conditions of EPMA were an acceleration voltage of 15 kV and an emission current of 5×10⁻⁷ A. The magnification was made 5000×. As the calibration curve, one prepared by measuring the average C concentration of Fe-0.01% C, Fe-0.05% C, and Fe-0.10% C alloys under the above conditions was used.

The measurement by point analysis was performed in 5 μm increments in the range of 0 to 100 μm from the bead toe to the opposite direction from the welded part starting from the interface of the plating layer and base steel sheet of the steel plate. The average value of the measurement values at the different positions was made the C concentration at a depth of 5 μm in the range of 0 to 100 μm.

The results of evaluation are shown in Table 3.

TABLE 3

| | | Non-heat affected zone | | Bead toe | | | |
|---|---|---|---|---|---|---|---|
| | | C ≤ 0.05% | Base steel sheet/plating | C | | Performance | |
| | | depth | interface roughness | concentration | Plating | Tensile | LME |
| No. | Class | (μm) | (μm) | (mass %) | type | strength | resistance |
| 1 | Ex. | 5 | 3.0 | 0.05 | A | A | A |
| 2 | Ex. | 10 | 2.2 | 0.04 | A | AA | A |
| 3 | Ex. | 27 | 2.5 | 0.02 | A | AA | AA |
| 4 | Ex. | 18 | 2.1 | 0.02 | A | AA | AA |
| 5 | Ex. | 17 | 1.7 | 0.01 | F | AA | AA |
| 6 | Ex. | 22 | 2.0 | <0.01 | A | AA | AAA |
| 7 | Ex. | 18 | 1.5 | <0.01 | A | AA | AAA |
| 8 | Ex. | 19 | 1.3 | <0.01 | A | AA | AA |
| 9 | Ex. | 18 | 1.0 | <0.01 | A | AA | AAA |
| 10 | Ex. | 20 | 1.8 | <0.01 | A | AA | AAA |
| 11 | Ex. | 10 | 1.5 | 0.02 | A | AA | AA |
| 12 | Ex. | 18 | 1.2 | <0.01 | C | AA | AA |
| 13 | Ex. | 6 | 2.5 | 0.04 | B | AA | A |
| 14 | Ex. | 6 | 2.4 | 0.05 | B | AA | A |
| 15 | Ex. | 18 | 1.2 | <0.01 | A | AAA | AAA |
| 16 | Ex. | 18 | 1.5 | <0.01 | A | AAA | AAA |
| 17 | Ex. | 18 | 1.8 | <0.01 | A | AAA | AA |
| 18 | Ex. | 24 | 1.7 | <0.01 | A | AAA | AAA |
| 19 | Ex. | 6 | 2.5 | 0.04 | B | AA | A |
| 20 | Ex. | 7 | 2.1 | 0.05 | D | AA | AA |
| 21 | Ex. | 7 | 2.2 | 0.03 | E | AA | AAA |
| 22 | Ex. | 40 | 1.9 | <0.01 | A | AAA | AAA |
| 23 | Ex. | 25 | 1.5 | <0.01 | A | AAA | AAA |
| 24 | Ex. | 23 | 2.2 | <0.01 | A | AAA | AAA |
| 25 | Ex. | 17 | 1.0 | <0.01 | A | AAA | AAA |
| 26 | Ex. | 17 | 1.7 | <0.01 | A | AAA | AAA |
| 27 | Ex. | 18 | 1.1 | <0.01 | A | AAA | AAA |
| 28 | Ex. | 15 | 1.2 | <0.01 | A | AAA | AAA |
| 29 | Comp. ex. | 2 | 2.6 | 0.19 | A | AAA | B |
| 30 | Comp. ex. | 2 | 2.6 | 0.14 | A | AAA | B |
| 31 | Comp. ex. | 2 | 2.5 | 0.13 | A | AAA | B |
| 32 | Comp. ex. | 4 | 2.2 | 0.08 | A | AAA | B |
| 33 | Comp. ex. | 3 | 2.5 | 0.12 | A | AAA | B |
| 34 | Comp. ex. | 7 | 2.5 | 0.06 | A | AAA | B |
| 35 | Comp. ex. | 3 | 2.6 | 0.09 | A | AAA | B |
| 36 | Comp. ex. | Not evaluable due to nonplating defect | | | | | |
| 37 | Comp. ex. | | | | | | |
| 38 | Comp. ex. | 1 | 2.4 | 0.06 | A | AAA | B |
| 39 | Comp. ex. | 4 | 2.5 | 0.07 | A | AAA | B |
| 40 | Comp. ex. | 2 | 2.5 | 0.07 | A | AAA | B |
| 41 | Comp. ex. | 7 | 2.4 | 0.08 | A | AAA | B |
| 42 | Comp. ex. | 10 | 3.3 | 0.12 | A | AAA | B |

*Underlines show outside scope of present invention or desired properties not obtained.

No. 29 is a comparative example with a large content of C in the steel sheet. Since the content of C of the steel sheet was large, it is believed that even with high dew point annealing, no progress was made in decarburization at the surface layer. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 30 is a comparative example with a small content of Si in the steel sheet and a small sum of the contents of Si and sol. Al. Since the content of Si of the steel sheet was small and the sum of the contents of Si and sol. Al was small, it is believed that even with high dew point annealing, no progress was made in decarburization at the surface layer and the ferrite was not stabilized. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 31 is a comparative example with a small content of Si in the steel sheet. Since the content of Si of the steel sheet was small, it is believed that even with high dew point annealing, no progress was made in decarburization at the surface layer and the ferrite was not stabilized. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 32 is a comparative example with a large content of Si in the steel sheet. Since the content of Si of the steel sheet was large, it is believed that even with high dew point annealing, external oxidation proceeded, oxide (scale) was formed on the surface layer of the steel sheet, and decarburization at the surface was suppressed. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 33 is a comparative example with a small content of sol. Al in the steel sheet. Since the content of sol. Al of the steel sheet was small, it is believed that even with high dew point annealing, no progress was made in decarburization at the surface layer and the ferrite was not stabilized. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 34 is a comparative example with a large content of sol. Al in the steel sheet. Since the content of sol. Al of the steel sheet was large, it is believed that even with high dew point annealing, external oxidation proceeded, oxide (scale) was formed on the surface layer of the steel sheet, and decarburization at the surface was suppressed. For this reason, the C concentration at a position of 0 to 100 μm from the bead toe to the opposite direction from the welded part became higher. As a result, the LME resistance at the time of production of the welded joint became inferior.

No. 35 is a comparative example with a small sum of the contents of Si and sol. Al of the steel sheet. Since the sum of the contents of Si and sol. Al was small, it is believed that even with high dew point annealing, no progress was made in decarburization at the surface layer and the ferrite was not stabilized. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 36 was low in dew point at the time of annealing, so at the time of annealing, phases containing Si, Mn, Al, and other oxides were formed at the outside of the steel sheet and, at the time of plating treatment, it is believed that mutual diffusion of the plating constituents and steel constituents was obstructed. As a result, suitable plating could not be obtained, so the welded joint was not evaluated.

No. 37 was high in dew point at the time of annealing, so it is believed a layer including oxides of Si, Mn, Al, etc. was formed at the outside of the steel sheet at the time of annealing and, at the time of plating, mutual dispersion of the plating constituents and steel constituents was obstructed. As a result, suitable plating was not performed, so the welded joint was not evaluated.

No. 38 was low in holding temperature at the time of annealing, so it is believed decarburization was not sufficiently promoted at the time of annealing. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 39 was high in holding temperature at the time of annealing, so it is believed decarburization was not sufficiently promoted at the time of annealing. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 40 was short in holding time at the time of annealing, so it is believed decarburization was not sufficiently promoted at the time of annealing. For this reason, the depth with a C concentration measured by GDS at the non-heat affected zone of 0.05% or less became smaller and the C concentration at a position of 0 to 100 μm from the bead toe to the opposite direction from the welded part became higher. As a result, the LME resistance at the time of production of the welded joint became inferior.

No. 41 was not brush ground in the pretreatment process, so it is believed that strain was not introduced into the surface of the steel sheet and decarburization did not proceed at the time of annealing. For this reason, the C concentration at a position 0 to 100 μm from the bead toe to an opposite direction from the welded part became higher. As a result, the LME resistance at the time of production of the welded joint became inferior.

In No. 42, a brush roll with a large grinding amount was used in the brush grinding of the pretreatment step, so it is believed that the surface of the steel sheet became greater in roughness and the ferrite phase did not become stable. For this reason, the C concentration at a position 0 to 100 μm from the bead toe to an opposite direction from the welded part became higher. As a result, the LME resistance at the time of production of the welded joint became inferior.

Nos. 1 to 28 are examples of the present invention. The LME at the time of welded joint production was suppressed. In examples where the depth with a C concentration at the non-heat affected zone of 0.05% or less was large and the C concentration at the position of 0 to 100 from the bead toe to the opposite direction from the welded part was small, it was confirmed that particularly excellent LME resistance was possessed.

### INDUSTRIAL APPLICABILITY

According to the present invention, it becomes possible to provide a welded joint suppressed in LME cracking at the time of production. The welded joint can be suitably used for automobiles, household electric appliances, building materials, and other applications, in particular for automobiles. Therefore, the present invention is an invention with extremely high industrial applicability.

### REFERENCE SIGNS LIST

11. steel sheet (top sheet)
12. steel sheet (bottom sheet)
13. welded part
14. bead toe
15. heat affected zone
21. steel sheet
22. steel sheet
23. welded part
24. bead toe
25. heat affected zone

1. A welded joint comprising two plated steel sheets with tensile strengths of 780 MPa or more joined by arc welding,
wherein
the welded joint comprises a welded part, heat affected zone, and non-heat affected zone;
the plated steel sheets comprise a base steel sheet and plating layer, the plating layer formed at least at part of the non-heat affected zone, the plating layer containing Zn;
the chemical composition of the base steel sheet of the two steel sheets comprises
C: 0.05 to 0.40%,
Si: 0.7 to 3.0%,
Mn: 0.1 to 5.0%,
sol. Al: 0.2 to 2.0%,
P: 0.0300% or less,
S: 0.0300% or less,
N: 0.0100% or less,
B: 0 to 0.010%,
Ti: 0 to 0.150%,
Nb: 0 to 0.150%,
V: 0 to 0.150%,
Cr: 0 to 2.00%,
Ni: 0 to 2.00%,
Cu: 0 to 2.00%,
Mo: 0 to 1.00%,
W: 0 to 1.00%,
Ca: 0 to 0.100%,
Mg: 0 to 0.100%,
Zr: 0 to 0.100%,
Hf: 0 to 0.100%,
REM: 0 to 0.100% and a balance of Fe and impurities;
a total value of contents of Si and sol. Al is 1.0% or more;
at the non-heat affected zone,
a depth with a C concentration measured by GDS of 0.05% or less in a depth direction of the base steel sheet starting from an interface of the plating layer and the base steel sheet of the plated steel sheet is 5 μm or more,
a roughness of the interface of the plating layer and the base steel sheet at a cross-section of the plated steel sheet is an Ra of 3.0 μm or less; and
in a range of 0 to 100 μm from a bead toe of the welded part to an opposite direction from the welded part, a C concentration at a depth of 5 μm of the base steel sheet starting from an interface of the plating layer and the base steel sheet of the plated steel sheet is 0.05% or less.

2. The welded joint according to claim 1, wherein the depth with a C concentration measured by GDS of 0.05% or less in a depth direction of the base steel sheet starting from an interface of the plating layer and the base steel sheet at the non-heat affected zone of the plated steel sheet is 15 μm or more.

3. The welded joint according to claim 1, wherein the roughness of the interface of the plating layer and the base steel sheet at a cross-section of the plated steel sheet of the non-heat affected zone is an Ra of 2.0 μm or less.

4. The welded joint according to claim 1, wherein
the depth with a C concentration measured by GDS of 0.05% or less in a depth direction of the base material starting from an interface of the plating layer and the base steel sheet at the non-heat affected zone of the plated steel sheet is 15 μm or more and
the roughness of the interface of the plating layer and the base steel sheet at a cross-section of the plated steel sheet of the non-heat affected zone is an Ra of 2.0 μm or less.

5. The welded joint according to claim 1, wherein in a range of 0 to 100 μm from a bead toe of the welded part to an opposite direction from the welded part, the C concentration at a depth of 5 μm of the base steel sheet starting from an interface of the plating layer and the base steel sheet of the plated steel sheet is 0.02% or less.

6. The welded joint according to claim 1, wherein in a range of 0 to 100 μm from a bead toe of the welded part to an opposite direction from the welded part, the C concentration measured b GDS at a depth of 5 μm of the base steel sheet starting from an interface of the plating layer and the base steel sheet of the plated steel sheet is 0.01% or less.

7. The welded joint according to claim 2, wherein in a range of 0 to 100 μm from a bead toe of the welded part to an opposite direction from the welded part, the C concentration at a depth of 5 μm of the base steel sheet starting from an interface of the plating layer and the base steel sheet of the plated steel sheet is 0.02% or less.

8. The welded joint according to claim 3, wherein in a range of 0 to 100 μm from a bead toe of the welded part to an opposite direction from the welded part, the C concentration at a depth of 5 μm of the base steel sheet starting from an interface of the plating layer and the base steel sheet of the plated steel sheet is 0.02% or less.

9. The welded joint according to claim 4, wherein in a range of 0 to 100 μm from a bead toe of the welded part to an opposite direction from the welded part, the C concentration at a depth of 5 μm of the base steel sheet starting from an interface of the plating layer and the base steel sheet of the plated steel sheet is 0.02% or less.

10. The welded joint according to claim 2, wherein in a range of 0 to 100 μm from a bead toe of the welded part to an opposite direction from the welded part, the C concentration measured b GDS at a depth of 5 μm of the base steel sheet starting from an interface of the plating layer and the base steel sheet of the plated steel sheet is 0.01% or less.

11. The welded joint according to claim 3, wherein in a range of 0 to 100 μm from a bead toe of the welded part to an opposite direction from the welded part, the C concentration measured b GDS at a depth of 5 μm of the base steel sheet starting from an interface of the plating layer and the base steel sheet of the plated steel sheet is 0.01% or less.

12. The welded joint according to claim 4, wherein in a range of 0 to 100 μm from a bead toe of the welded part to an opposite direction from the welded part, the C concentration measured b GDS at a depth of 5 μm of the base steel sheet starting from an interface of the plating layer and the base steel sheet of the plated steel sheet is 0.01% or less.
